(19) United States
(12) Patent Application Publication
(10) Pub. No.: US 2026/0129146 A1
(43) Pub. Date: May 7, 2026

(54) VIRTUAL DESKTOP CREATION AND APPLICATION NAVIGATION TO INCREASE ACCESS TO SHARED INFORMATION

(71) Applicant: International Business Machines Corporation, Armonk, NY (US)

(72) Inventors: Zhe Yan, Beijing (CN); Li Li Guan, Beijing (CN); Rong Zhao, Beijing (CN); Li Bo Zhang, Beijing (CN); Hao Xiang Wu, Beijing (CN)

(21) Appl. No.: 18/936,712

(22) Filed: Nov. 4, 2024

(51) Int. Cl. H04N 7/15; G06F 3/14; H04N 21/431

(52) U.S. Cl. CPC H04N 7/152; G06F 3/1454; H04N 21/4312

(57) ABSTRACT

A method, according to one approach, includes: analyzing a screen sharing video stream in response to receiving the screen sharing video stream from a presenter's computer. The method also includes identifying application information and navigation actions included in the screen sharing video stream. Navigation metadata is generated in real-time, where the navigation metadata includes application static information and dynamic navigation actions. The navigation metadata is also sent to at least one participant of the screen sharing video. Furthermore, the method includes causing the at least one participant to reorganize keyframes and build up a virtual desktop using the navigation metadata sent.

### BACKGROUND

The present invention relates to distributed communication systems, and more specifically, this invention relates to increasing accessibility during video calls.

Web conferencing is an umbrella term which includes various types of online audio and/or video collaborative services, including webinars, video calls, group calls using voice over Internet protocol, etc. Applications for web conferencing include meetings, training events, lectures, presentations shared between web-connected computers, etc.

In general, web conferencing is made possible by Internet technologies which allow for communication to exist between different locations. Web conferencing thereby offers data streams of text-based messages, audio signals, video and/or still images, etc., to be shared simultaneously, across geographically dispersed locations.

Web conferencing has become a frequently used tool to facilitate virtual work meetings and other group environments, like online teaching. In these online meetings, a presenter may share a view of what is currently displayed on their personal computer screen in order to direct participants (e.g., viewers) of the online meeting to specific content, including slides, spread sheets, videos, demo applications, etc.

### SUMMARY

A method, according to one approach, includes: analyzing a screen sharing video stream in response to receiving the screen sharing video stream from a presenter's computer. The method also includes identifying application information and navigation actions included in the screen sharing video stream. Navigation metadata is generated in real-time, where the navigation metadata includes application static information and dynamic navigation actions. The navigation metadata is also sent to at least one participant of the screen sharing video. Furthermore, the method includes causing the at least one participant to reorganize keyframes and build up a virtual desktop using the navigation metadata sent.

A computer program product, according to another approach, includes: one or more computer-readable storage media. The computer program product also includes program instructions that are stored on the one or more storage media to perform any combination(s) of the foregoing methodologies.

A computer system, according to another approach, includes: a processor set, and one or more computer-readable storage media. The computer system also includes program instructions that are stored on the one or more storage media to cause the processor set to perform any combination(s) of the foregoing methodologies.

A method, according to still another approach, includes: receiving navigation metadata from a central server. The navigation metadata is used to reorganize keyframes and build up a virtual desktop. The method also includes loading a current application in the virtual desktop. The current application is further used to display a screen sharing video stream received from a presenter's computer. Furthermore, in response to receiving one or more navigation inputs from a participant, the virtual desktop is updated to reflect the one or more navigation inputs. The one or more navigation inputs are received from the participant in response to interacting with a user interface (UI) that corresponds to the virtual desktop. The one or more navigation inputs may include switching between displayed applications and/or adjusting a view in a current application.

A computer program product according to yet another approach, includes: one or more computer-readable storage media. The computer program product also includes program instructions that are stored on the one or more storage media to perform any combination(s) of the foregoing methodologies.

Other aspects and implementations of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one approach.

FIG. 2A is a representational view of a distributed system, in accordance with one approach.

FIG. 2B is a representational view of components in a portion of the distributed system of FIG. 2A, in accordance with one approach.

FIG. 3A is a flowchart of a method, in accordance with one approach.

FIG. 3B is a flowchart of sub-processes for one of the operations in the method of FIG. 3A, in accordance with one approach.

FIG. 3C is a flowchart of sub-processes for one of the operations in the method of FIG. 3A, in accordance with one approach.

FIG. 4A is a representational view of a GUI at a group call participant location, in accordance with an in-use example.

FIG. 4B is another representational view of a GUI at a group call participant location, in accordance with an in-use example.

FIG. 4C is another representational view of a GUI at a group call participant location, in accordance with an in-use example.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods and computer program products for analyzing screen sharing video streams generated by presenters. Approaches herein may thereby involve capturing application content and navigation actions in and/or between applications, reorganize keyframes, and build virtual desktops that are configured to be deployed at respective participant locations. These virtual desktops enable the participant to navigate content that has been shared over the video stream easily, e.g., as if the participant is interacting with a local application. This desirably allows for the user experience of an online meeting to be significantly improved by enabling access to information that was previously inaccessible, particularly during a video call correlated with the video stream. In other words, participants of the video call are able to revisit any portion of what the presenter has shared and even navigate through the content during an ongoing meeting in application view, e.g., as will be described in further detail below.

In one general approach, a method includes: analyzing a screen sharing video stream in response to receiving the screen sharing video stream from a presenter's computer. The method also includes identifying application information and navigation actions included in the screen sharing video stream. Navigation metadata is generated in real-time, where the navigation metadata includes application static information and dynamic navigation actions. The navigation metadata is also sent to at least one participant of the screen sharing video. Furthermore, the method includes causing the at least one participant to reorganize keyframes and build up a virtual desktop using the navigation metadata sent.

Approaches herein are thereby able to provide participants the ability to navigate through applications that are shared during a group call by creating a virtual desktop. For instance, applications are able to identify application static information from keyframes in a screen sharing video stream received from a presenter. Moreover, by capturing actions which cause screen change, the actions may be bound with respective keyboard events and/or element events. The keyframes are further reorganized and used to build a virtual desktop which contains applications displayed by the presenter, as well as actions (e.g., navigation information) received from the participant side. As a result, a participant is able to interact with the virtual desktop to view a desired application, even using inputs (e.g., a keyboard, computer mouse, touchscreen, etc.) to navigate in the desired application.

In some implementations, identifying application information and navigation actions included in the screen sharing video stream includes: identifying application static information from keyframes using object detection and image processing techniques. Navigation actions which cause screen change are also captured, and duplicate keyframes are identified. Additional information is also captured, such as application switching, link source, and target application.

As noted above, differentiating between static application information and actions that result in screen change, allows approaches herein to develop an understanding of which portions of a video stream illustrate new information. Moreover, by capturing actions which cause screen change and result in the new information being illustrated, these actions may be bound with respective keyboard events and/or element events that can be represented in the virtual desktop available to participants of the group call. This may be accomplished at least in part by using this information to reorganize the keyframes used in the virtual desktop.

In some implementations, capturing navigation actions which cause screen change includes identifying element click events, identifying scrollbar change, and leveraging vocal input received from the presenter. Moreover, the application static information identified from the keyframes may include application type, title, fixed area, content area, etc.

Again, static information is unchanged for at least a portion of the video stream, and is therefore not a rich source of details related to the video stream itself. However, navigation actions which cause screen change correspond to sections of the video stream in which the presenter changed the information that is displayed. Thus, by differentiating between the two, approaches herein are able to extend the same or similar screen change capabilities to participants of a group call, thereby providing at least limited access to any information shared during the video stream.

In some implementations, the screen sharing video stream is part of a video call connecting the presenter with the participant and one or more other participants. Accordingly, audio and visual information (e.g., video file(s)) is exchanged between the presenter and the participants. It follows that approaches herein may be used to provide each participant of a group video call access to any content that has been shared during the call. This allows participants to interact with a virtual representation of the applications used by the presenter during the call, and access any of the presented material without interrupting the ongoing group video call.

In another general approach, a computer program product includes: one or more computer-readable storage media. The computer program product also includes program instructions that are stored on the one or more storage media to perform any combination(s) of the foregoing methodologies.

In another general approach, a computer system includes: a processor set, and one or more computer-readable storage media. The computer system also includes program instructions that are stored on the one or more storage media to cause the processor set to perform any combination(s) of the foregoing methodologies.

In still another general approach, a method includes: receiving navigation metadata from a central server. The navigation metadata is used to reorganize keyframes and build up a virtual desktop. The method also includes loading a current application in the virtual desktop. The current application is further used to display a screen sharing video stream received from a presenter's computer. Furthermore, in response to receiving one or more navigation inputs from a participant, the virtual desktop is updated to reflect the one or more navigation inputs. The one or more navigation inputs are received from the participant in response to interacting with a user interface (UI) that corresponds to the virtual desktop. The one or more navigation inputs may include switching between displayed applications and/or adjusting a view in a current application.

Again, approaches herein are able to provide participants the ability to navigate through applications that are shared during a group call by creating a virtual desktop for each participant. For instance, keyframes may be reorganized and used to build a virtual desktop at a given participant's location. The virtual desktop may include representations of applications, and the information therein displayed by the presenter during the video stream. The virtual desktop is also configured such that actions (e.g., navigation information) received from the participant side impact the information that is presented to the respective participant. As a result, a participant is able to interact with the virtual desktop to view a desired application, even using inputs (e.g., a keyboard, computer mouse, touchscreen, etc.) to navigate in the desired application(s) without interrupting the ongoing video stream.

In some implementations, the one or more navigation inputs are received from the participant in response to interacting with a user interface (UI) that corresponds to the virtual desktop. Furthermore, the one or more navigation inputs may include switching between displayed applications and/or adjusting a view in a current application in some instances.

Again, approaches herein desirably allow for each participant of a group video stream to navigate through the applications used by the presenter to display information. Moreover, by allowing the participants to enter navigation options in their own UI, approaches herein are able to provide access to desired information without impacting the presenter and/or the flow of the presentation for others.

In some implementations, the navigation metadata includes application static information and dynamic navigation actions. Moreover, using the navigation metadata to reorganize keyframes and build up the virtual desktop includes: grouping keyframes into applications, and displaying keyframes in an application view. Moreover, hotspots are rendered on the keyframes based at least in part on the dynamic navigation actions.

It follows that at least dynamic navigation actions included in the navigation metadata may be used to identify hotspots on the keyframes. With respect to the present description, “hotspots” on a keyframe are intended to refer to areas in a grouping of keyframes which experience changes to the content therein. Hotspots may thereby identify areas in keyframes that correspond to a same application, which change across the keyframes in that group. This information is desirable, as it may be used to direct a participant's attention to a specific area of a keyframe, add supplemental information to a keyframe, integrate navigation inputs that are available to participants, etc.

In some implementations, the screen sharing video stream is part of a video call connecting the presenter with the participant and one or more other participants. In such implementations, audio and/or visual information is exchanged between the presenter and the participants. Accordingly, audio and visual information (e.g., video file(s)) is exchanged between the presenter and the participants. It follows that approaches herein may be used to provide each participant of a group video call access to any content that has been shared during the call. This allows participants to interact with a virtual representation of the applications used by the presenter during the call, and access any of the presented material without interrupting the ongoing group video call.

In yet another general approach, a computer program product includes: one or more computer-readable storage media. The computer program product also includes program instructions that are stored on the one or more storage media to perform any combination(s) of the foregoing methodologies.

In still another general approach, a screen sharing video stream is received from a presenter's computer while conducting (e.g., hosting) a group video call between the presenter and a number of participants. During the screen sharing video stream, application information and navigation actions taken by the presenter are identified and used to generate navigation metadata in real-time. The navigation metadata may thereby differentiate between portions of the screen sharing video stream that remain unchanged for at least a portion of the video stream, and portions that involve the displayed information changing. This navigation metadata may thereby be sent to each of the participants on the group call, along with instructions that cause each of the respective participants to build a virtual desktop locally. One or more applications may be loaded into the virtual desktop and used at the respective participant locations to display any desired portion of a screen sharing video stream received from the presenter's computer. Specifically, navigation inputs may be received from a participant by interacting with a UI, and used to update the information displayed to the respective participant.

Various aspects of the present disclosure are described by narrative text, flowcharts, block diagrams of computer systems and/or block diagrams of the machine logic included in computer program product (CPP) approaches. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product approach (“CPP approach” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as improved video stream access code at block 150 for analyzing screen sharing video streams generated by presenters (really the presenters'computers). Approaches herein may thereby involve capturing application content and navigation actions in and/or between applications, reorganize keyframes, and build virtual desktops that are configured to be deployed at respective participant locations. These virtual desktops enable the participant to navigate content that has been shared over the video stream easily, e.g., as if the participant is interacting with a local application. This desirably allows for the user experience of an online meeting to be significantly improved by enabling access to information that was previously inaccessible, particularly during a video call correlated with the video stream. In other words, participants of the video call are able to revisit any portion of what the presenter has shared and even navigate through the content during an ongoing meeting in application view, e.g., as will be described in further detail below.

In addition to block 150, computing environment 100 includes, for example, computer 101, wide area network (WAN) 102, end user device (EUD) 103, remote server 104, public cloud 105, and private cloud 106. In this approach, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

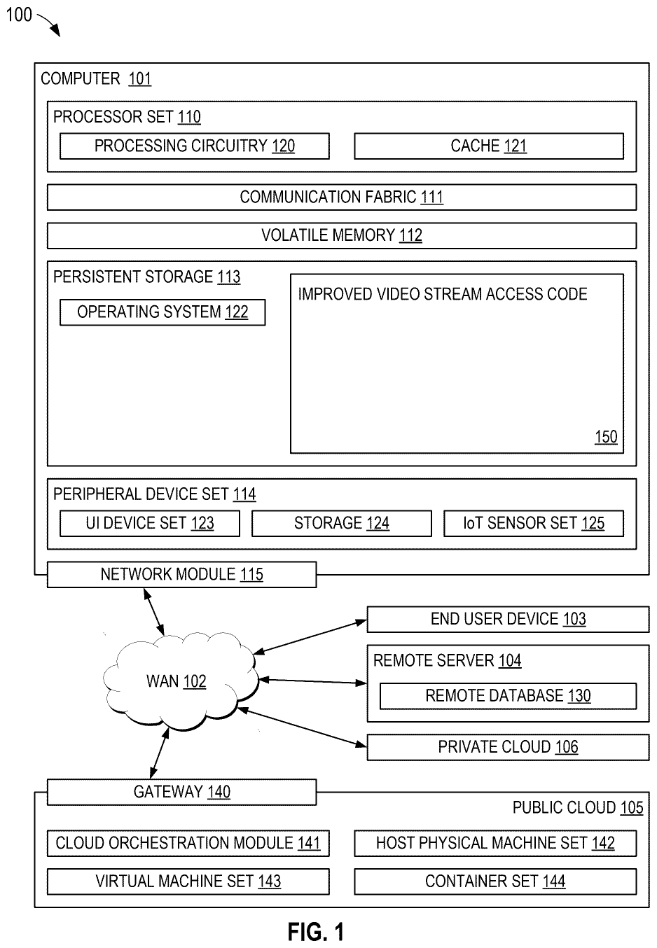

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various approaches, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some approaches, storage 124 may take the form of a quantum computing storage device for storing data in the form of qubits. In approaches where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some approaches, network control functions and network forwarding functions of network module 115 are performed on the same physical hardware device. In other approaches (for example, approaches that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some approaches, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some approaches, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other approaches a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this approach, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some approaches, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various approaches may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various implementations.

As noted above, web conferencing is an umbrella term which includes various types of online collaborative services that exchange audio and/or video signals. These include webinars, video calls, group calls using voice over Internet protocol, etc. Applications for web conferencing include meetings, training events, lectures, presentations shared between web-connected computers, etc. In general, web conferencing is made possible by Internet technologies which allow for communication to exist between different locations. Web conferencing thereby offers data streams of text-based messages, audio signals, video and/or still images, etc., to be shared simultaneously, across geographically dispersed locations.

Web conferencing has become a frequently used tool to facilitate virtual work meetings and other group environments, like online teaching. In these online meetings, a presenter may share a view of what is currently displayed on their personal computer screen in order to direct participants (e.g., viewers) of the online meeting to specific content, including slides, spread sheets, videos, demo applications, etc. While it is beneficial for information to be exchanged between each location in a virtual meeting to emulate an in-person meeting, this may not be desirable in some situations. For instance, a participant of a group video call may wish to revisit portions of a presentation after the presenter has moved on. However, conventional products specify that the shared screen represents the focus of the presenter, limiting participants to only be able to view what the presenter wishes to display on the screen of their computer.

While this may be acceptable for passive participants of a group video call, it is common for other participants to review and compare information presented at different points in the video call. For example, a video call participant may wish to confirm and/or compare details presented at different points of the video call and/or using different applications. However, conventional products are simply unable to facilitate this desired access. Rather, participants are forced to obtain a recording of the video call after it has concluded (assuming one is available in the first place), open it locally, and jump between different points in the recording to attempt the desired detail confirmation and/or comparison. This undesirably involves the participant correlating local file content with the presenter's shared content, and does not allow for the sharing of any live demonstrations. Participants may alternatively attempt to take screenshots of content presented during the group call, but this option is only available while the content is being shared by the presenter. As a result, participants often miss opportunities to capture desired content and/or do not realize specific content should be captured until the presenter has moved on to new content.

Attempts to show image thumbnails of what is shown on a presenter's screen also fall short, as doing so is not suitable for continuous screen changing scenarios and is unable to support actions on applications. Participants are thereby unable to access desired content, much less with intuitive navigation actions. Similarly, file sharing and other attempts to exchange specific information must be done before a call has commenced and is not suitable for online scenarios. It follows that conventional products have been unable to achieve desirable access of information.

In sharp contrast to these conventional shortcomings, approaches herein are desirably able to facilitate participants navigating through applications shared during a group call by creating a virtual desktop. For instance, applications are able to identify application static information from keyframes in a screen sharing video stream received from a presenter's computer. Moreover, by capturing actions which cause screen change, the actions may be bound with respective keyboard events and/or element events. The keyframes are further reorganized and used to build a virtual desktop which contains applications displayed by the presenter, as well as actions (e.g., navigation information) received from the participant side (e.g., a participant's computer). Accordingly, a participant is able to interact with the virtual desktop to view a desired application, even using inputs (e.g., a keyboard, computer mouse, touchscreen, etc.) to navigate in the desired application, e.g., as will be described in further detail below.

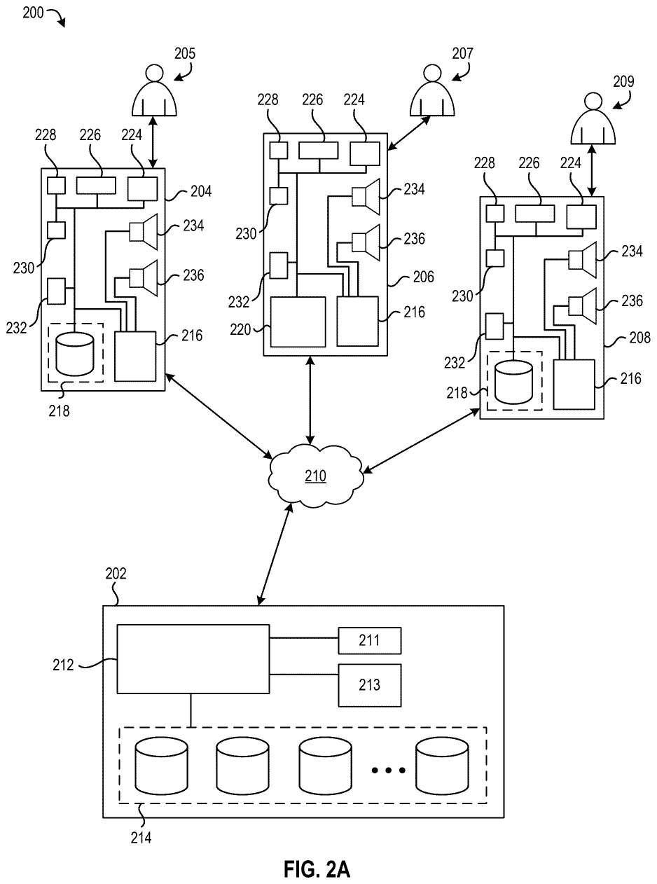

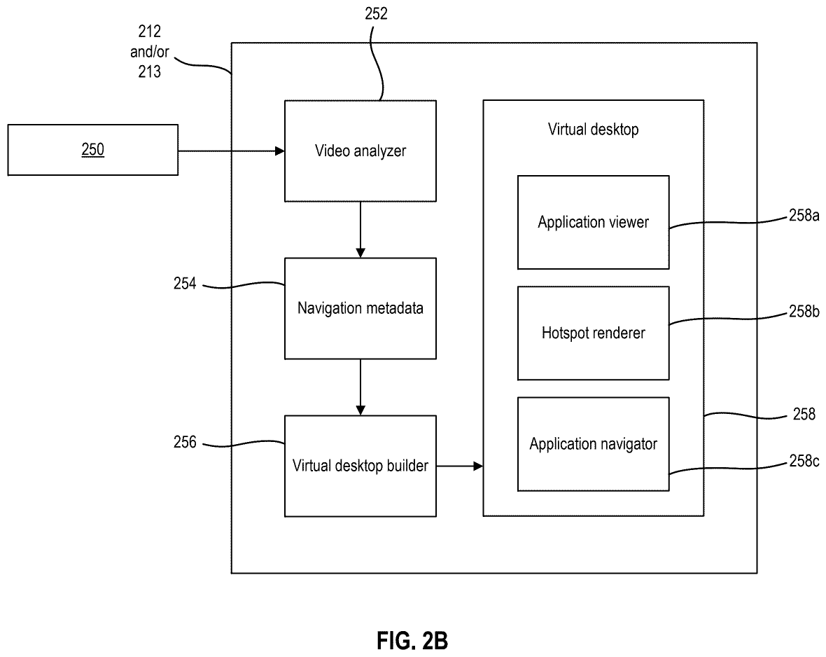

Looking now to FIG. 2A, a system 200 having a distributed architecture is illustrated in accordance with one approach. As an option, the present system 200 may be implemented in conjunction with features from any other approach listed herein, such as those described with reference to the other FIGS., such as FIG. 1. However, such system 200 and others presented herein may be used in various applications and/or in permutations which may or may not be specifically described in the illustrative approaches or implementations listed herein. Further, the system 200 presented herein may be used in any desired environment. Thus FIG. 2A (and the other FIGS.) may be deemed to include any possible permutation.

As shown, the system 200 includes a central server 202 that is connected to electronic devices 204, 206, 208 accessible to the respective participants 205, 207 and presenter 209. Each of these electronic devices 204, 206, 208, the participants 205, 207, and presenter 209 may be separated from each other such that they are positioned in different geographical locations. For instance, the central server 202 and electronic devices 204, 206, 208 are connected to a network 210.

The network 210 may be of any type, e.g., depending on the desired approach. For instance, in some approaches the network 210 is a WAN, e.g., such as the Internet. However, an illustrative list of other network types which network 210 may implement includes, but is not limited to, a LAN, a PSTN, a SAN, an internal telephone network, etc. As a result, any desired information, data, commands, instructions, responses, requests, etc. may be sent between participants 205, 207 and presenter 209 using the electronic devices 204, 206, 208 and/or central server 202, regardless of the amount of separation which exists therebetween, e.g., despite being positioned at different geographical locations.

However, it should also be noted that two or more of the electronic devices 204, 206, 208 and/or central server 202 may be connected differently depending on the approach. According to an example, which is in no way intended to limit the invention, two edge compute nodes may be located relatively close to each other and connected by a wired connection, e.g., a cable, a fiber-optic link, a wire, etc.; etc., or any other type of connection which would be apparent to one skilled in the art after reading the present description.

While each of the electronic devices 204, 206, 208 and central server 202 are shown as being connected to a same network 210, it should be noted that information may be sent between the locations differently depending on the implementation. According to an example, which is in no way intended to limit the invention, a shared (e.g., open) communication channel corresponding to a group video chat may be formed between each of the electronic devices 204, 206, 208. This shared communication channel may be formed by the processor 212 in response to a scheduled meeting, receiving an impromptu request from a participant, a predetermined condition being met, etc. The shared communication channel thereby allows the participants 205, 207 and presenter 209 to exchange information (e.g., audio signals, video images, typed messages, etc.) freely between each other. However, it may not always be desirable that information is sent to every participant of a group video chat. Accordingly, some approaches herein may also allow for additional communication channels to share information between certain ones of the participants over private (e.g., secure) communication channels. In other words, private communication channels may extend between subsets of participants on the group video chat, in addition to a shared communication channel that extends between each participant on the group video chat. These private communication channels may be activated and/or deactivated by a host (e.g., organizer) of the group video chat. Moreover, the information sent over private communication channels may be combined with information that is sent over a shared communication channel differently depending on the implementation, e.g., as would be appreciated by one skilled in the art after reading the present description.

It should be noted that while implementations herein are described in the context of information that is being exchanged between participants, this is in no way intended to be limiting. For instance, while a “participant” is described in approaches herein as an individual, the participant may actually be an application, an organization, etc. The use of “data” and “information” herein is in no way intended to be limiting either, and may include any desired type of details, e.g., such as physical data storage locations, sensor readings, inputs received from participants, logical data storage locations, logical to physical tables, data write details, etc.

With continued reference to FIG. 2A, the electronic devices 204, 206, 208 are shown as having a different configuration than the central server 202. For example, in some implementations the central server 202 includes a large (e.g., robust) processor 212 coupled to a cache 211, an AI module 213, and a data storage array 214 having a relatively high storage capacity. The central server 202 is thereby able to process and store a relatively large amount of data, as well as evaluate and process screen sharing video streams received from a presenter's computer and intended for one or more participants of a group video call. This allows the central server 202 to connect to, and manage, the exchange of information between multiple different remote participant locations. For instance, this may be achieved at least in part by receiving a screen sharing video stream from the presenter 209, using the video stream to generate a virtual desktop, and delivering the video stream along with the virtual desktop to each of the participants 205, 207.

Moreover, in response to receiving one or more navigation inputs from the participant while interacting with a user interface (UI) that corresponds to (e.g., communicates and/or otherwise interacts with) the virtual desktop, the virtual desktop supplied to that participant is updated to reflect the one or more navigation inputs. In other words, the central server 202 and/or the participant's local compute components (e.g., personal computer) is able to evaluate navigation inputs received from the presenter and adjust the details that are displayed to the participant accordingly. Participants of a group video call are thereby able to obtain customized and focused views of what the presenter has displayed during the screen sharing video stream. This allows the participants of the video call to revisit any portion of what the presenter shared and even navigate through the content during an ongoing meeting, e.g., as if the participants were each navigating through their own respective environments. Central server 202 may achieve this by using processor 212 and/or AI module 213 to perform one or more of the operations below in method 300.

For example, referring momentarily to FIG. 2B, various logical and/or physical components that may be included in the processor 212 and/or AI module 213 of the central server 202 in FIG. 2A are illustrated in accordance with one approach. As an option, the present components may be implemented in conjunction with features from any other approach listed herein, such as those described with reference to the other FIGS., such as FIG. 1. However, such components and others presented herein may be used in various applications and/or in permutations which may or may not be specifically described in the illustrative approaches or implementations listed herein. Thus FIG. 2B (and the other FIGS.) may be deemed to include any possible permutation.

As shown, a video stream and corresponding information 250 is received, e.g., from a presenter's computer. The corresponding information preferably includes the information associated with the application being used by the presenter in the video stream. Thus, the corresponding information may include information associated with a network-based application facilitating the communication path(s) between the presenter and participants of the video call, and/or application(s) the presenter is using to display the content of the screen sharing video stream.

The received video stream is provided to a video analyzer 252. In preferred approaches, the video analyzer 252 is able (e.g., configured) to identify information associated with the video stream and/or corresponding application. For instance, the video analyzer 252 may be able to extract application static information from keyframes, as well as application metadata, e.g., such as application type, application title, fixed area items (e.g., menu, navigation buttons, etc.), content area items (e.g., slides, spread sheets, video content, pages, etc.), etc.

The video analyzer 252 is also preferably able to capture application navigation actions from video and/or audio signals that are received in the video stream. For example, the video analyzer 252 may identify changing slides in a presentation, scrolling up/down/right/left in a spreadsheet, playing/dragging timeline/pausing a video, navigating in an application, switching between applications, etc. Accordingly, the video analyzer 252 is shown as producing navigation metadata 254 which corresponds to navigation inputs provided by the presenter during the video stream.

Moreover, the navigation metadata 254 is provided to a virtual desktop builder 256. There, the navigation metadata 254 is used to develop the virtual desktop 258. For instance, the navigation metadata 254 is used by an application viewer 258a to group keyframes based on their respective applications. In other words, the application viewer 258a may group the keyframes and use the groups to generate respective views of the corresponding applications.

Moreover, the hotspot renderer 258b is configured to add hotspots to the keyframes based at least in part on dynamic navigation actions performed by the presenter in the video stream. Thus, at least dynamic navigation actions included in the navigation metadata 254 are used to identify hotspots on the keyframes. With respect to the present description, “hotspots” on a keyframe are intended to refer to areas in a grouping of keyframes which experience changes to the content therein. Hotspots may thereby identify areas in keyframes that correspond to a same application, which change across the keyframes in that group. This information is desirable, as it may be used to direct a participant's attention to a specific area of a keyframe, add supplemental information to a keyframe, integrate navigation inputs that are available to participants, etc.

Furthermore, the application navigator 258c uses the hotspots and related groups of keyframes to adjust how the virtual desktop is configured to operate. In other words, the application navigator 258c adjusts the virtual desktop to replicate the video stream in real-time, while also providing the participant options to view content shared previously in the video stream, e.g., as described herein.

Returning now to FIG. 2A, the AI module 213 may include any desired number and/or type of AI based models, e.g., such as machine learning models, deep learning models, neural networks, etc. In preferred approaches, the AI module 213 may include one or more AI based models that have been trained to evaluate video streams and identify content of interest. For example, one or more AI based models may be trained to evaluate screen sharing video streams and identify applications that are being used by a presenter while creating the video stream, as well as navigation actions that are performed by the presenter. Moreover, the AI based models may be trained to generate and update navigation metadata which corresponds to actions taken by the presenter in real-time. Further still, AI based models may be trained to use the navigation metadata to reorganize keyframes and at least partially build a virtual desktop configured to be deployed at the location of a participant of a group video call, e.g., as will be described in further detail below.

The central server 202 may also store at least some information about the different electronic devices 204, 206, 208, participants 205, 207, and/or presenter 209. For instance, user defined authentication information (e.g., passwords), activity-based information (e.g., geographic location), application preferences, performance metrics, meeting invite lists, attendee records, etc., may be collected from the participants 205, 207 and/or presenter 209 leading up to, and during, a video stream and stored in memory for future use. Additionally, at least some of the information that is collected from the participants and/or presenter may be hashed and randomized before being stored in memory in some approaches. For instance, some approaches include encrypting and storing preferential selections, geographical location information, passwords, etc. This information can later be used to customize at least certain details of a virtual desktop that is created. For example, a machine learning model may be trained using details of applications viewed during screen sharing video streams as well as the participants and presenters given access thereto. The machine learning model may thereby be used to generate virtual desktops for the respective participants, based at least in part on patterns identified in the training data.

Looking now to the electronic devices 204, 206, 208, each are shown as including a processor 216 coupled to memory 218, 220. The memory implemented at each of the electronic devices 204, 206, 208 may be used to store data received from one or more sensors (not shown) in communication with the respective electronic devices, the participants 205, 207 and/or presenter 209 themselves, the central server 202, different systems also connected to network 210, etc. It follows that different types of memory may be used. According to an example, which is in no way intended to limit the invention, electronic devices 204 and 208 may include hard disk drives as memory 218 while electronic device 206 includes a solid state memory module as memory 220.

The processor 216 is also connected to a display screen 224, a keyboard 226, a computer mouse 228, a microphone 230, and a camera 232. The processor 216 may thereby be configured to receive inputs from the keyboard 226 and computer mouse 228 as entered by the participants 205, 207 and/or presenter 209. These inputs typically correspond to information presented on the display screen 224 while the entries were received. Moreover, the inputs received from the keyboard 226 and computer mouse 228 may impact the information shown on display screen 224, data stored in memory 218, 220, information collected from the microphone 230 and/or camera 232, status of an operating system being implemented by processor 216, etc.

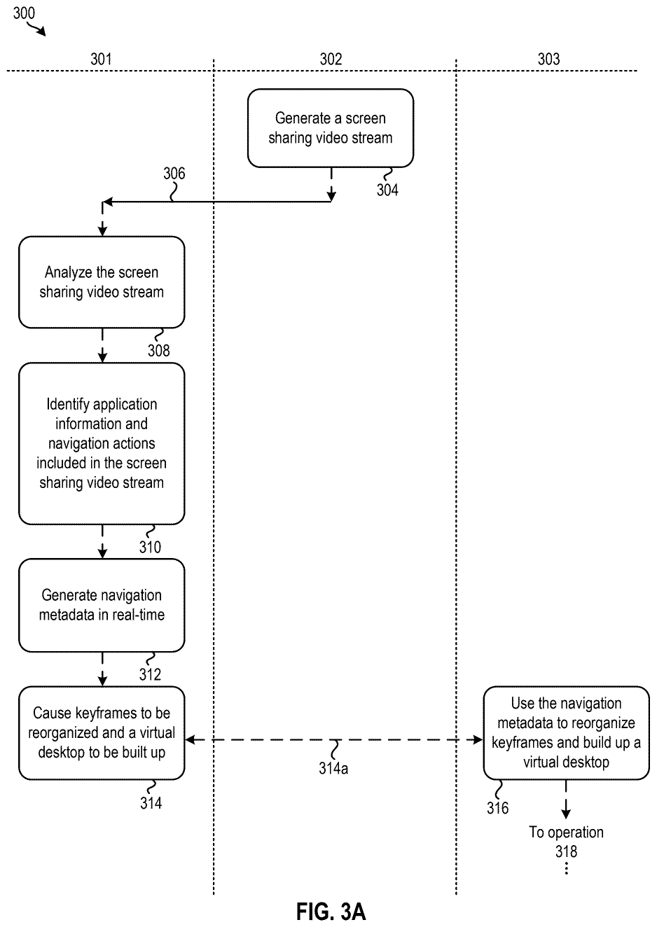

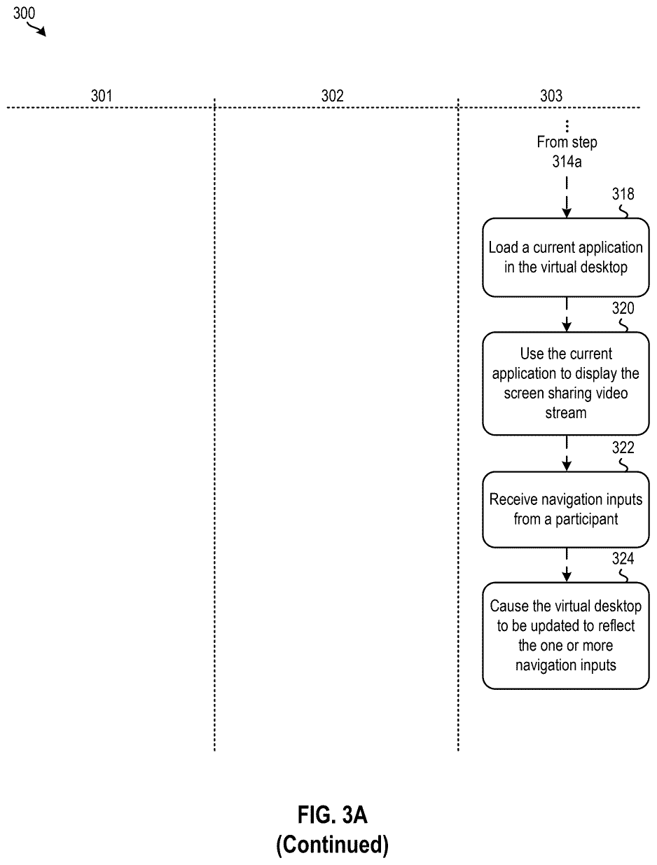

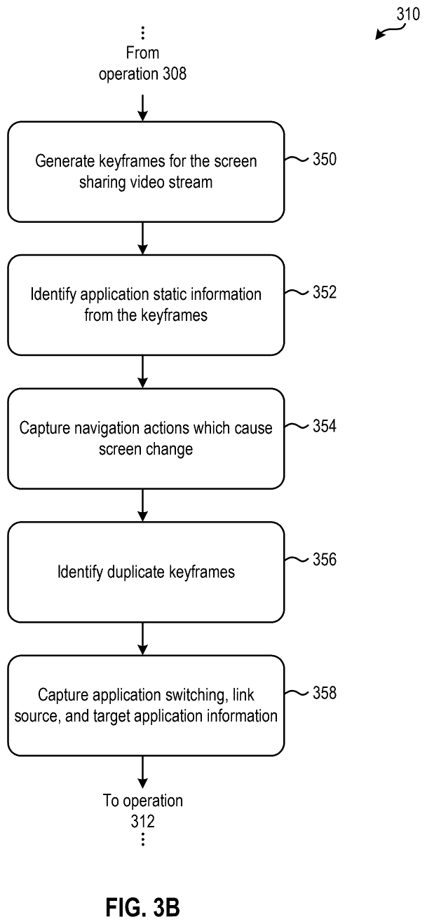

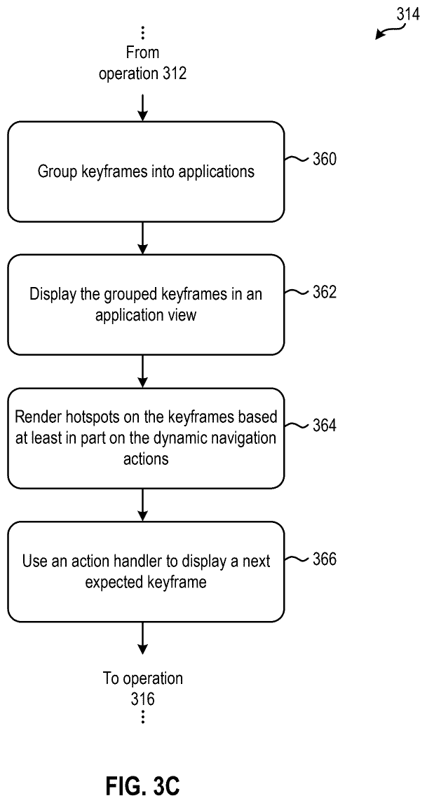

Each of the electronic devices 204, 206, 208 are also shown as including a first speaker 234 and a second speaker 236. The speakers 234, 236 correspond to a different audio channel extending from processor 216. Accordingly, each of the speakers 234, 236 may be used to perform the same or different audio signals compared to each other. It should also be noted that the display screen 224, the keyboard 226, the computer mouse 228, microphone 230, camera 232, and speakers 234, 236 are each coupled directly to the processor 216 in the present implementation. Accordingly, inputs received from the keyboard 226 and/or computer mouse 228 may be evaluated before being implemented in the operating system and/or shown on display screen 224. For example, processors 216 in the electronic devices 204, 206, 208 may perform any one or more of the operations described below in method 300 of FIG. 3A in order to improve access to information exchanged (e.g., presented) between participants on a video call (e.g., web conference).

While the electronic devices 204, 206, 208 are depicted as including similar components and/or design, it should again be noted that each of these electronic devices 204, 206, 208 may include any desired components which may be implemented in any desired configuration. In some instances, each user device (e.g., mobile phone, laptop computer, desktop computer, etc.) connected to a network may be configured differently to provide each location with a different functionality. According to an example, which is in no way intended to limit the invention, electronic devices 204 may include a cryptographic module (not shown) that allows the participant 205 to produce encrypted data, while electronic devices 206 includes a data compression module (not shown) that allows for data to be compressed before being sent over the network 210 and/or stored in memory, thereby improving performance of the system by reducing network strain and/or compute overhead at the electronic device itself. It follows that the different electronic devices (e.g., user devices) in system 200 may have different performance capabilities.

Looking now to FIG. 3A, a method 300 for analyzing screen sharing video streams generated by presenters is shown according to one approach. One or more of the operations in method 300 may thereby be performed to capture application content and navigation actions in and/or between applications, reorganize keyframes, and build virtual desktops that are configured to be deployed at respective participant locations. These virtual desktops enable the participant to navigate content that has been shared over the video stream easily, e.g., as if the participant is interacting with a local application. This desirably allows for the user experience of an online meeting to be significantly improved by enabling access to information that was previously inaccessible, particularly during a video call correlated with the video stream. For instance, a participant can obtain customized focus views of content the presenter has displayed using one or more applications at the presenter location during the screen sharing video stream. In other words, participants of the video call are able to revisit any portion of what the presenter has shared and even navigate through the content during an ongoing meeting in application view. Again, this provides access to details that has previously been unavailable, thereby improving the user experience while also improving the efficiency by which information can be accessed. For example, presenters are able to access previous slides, charts, text, etc. without interrupting the presenter and disrupting the flow of the overarching group video call.

In some approaches, one or more of the operations in method 300 may be performed by AI based models that have undergone training to identify and interpret screen sharing in video streams. Accordingly, the operations of method 300 may be performed continually in the background of an operating system without requesting input from a participant (e.g., human). Moreover, while certain information (e.g., warnings, reports, read requests, etc.) may be generated and/or issued to a participant, it is again noted that the various operations of method 300 can be repeated in an iterative fashion to process details as they are received in the video stream in real-time. Thus, method 300 may be performed in accordance with the present invention in any of the environments depicted in FIGS. 1-2, among others, in various approaches. Of course, more or less operations than those specifically described in FIG. 3A may be included in method 300, as would be understood by one of skill in the art upon reading the present descriptions.

Each of the steps of the method 300 may be performed by any suitable component of the operating environment. For example, each of the nodes 301, 302, 303 shown in the flowchart of method 300 may correspond to one or more processors positioned at a different location in a distributed data production and storage system. Moreover, each of the one or more processors are preferably configured to communicate with each other.

In various implementations, the method 300 may be partially or entirely performed by a controller, a processor, etc., or some other device having one or more processors therein. The processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

As mentioned above, FIG. 3A includes nodes 301, 302, 303, each of which represent one or more processors, controllers, computers, etc., positioned at a different location in a distributed data storage system. For instance, node 301 may include one or more processors located at a central data storage location (e.g., cloud server) of a distributed compute system (e.g., see central server 202 of FIG. 2A above). Node 302 may include one or more processors that are located in an electronic device at a presenter location that may be generating a video stream (e.g., see processor 216 of electronic device 208 in FIG. 2A above). Furthermore, node 303 may include one or more processors that are located in an electronic device at a participant location that may be running an application (e.g., see processor 216 of electronic device 206 in FIG. 2A above). Accordingly, commands, data, requests, etc. may be sent between the nodes 301, 302, 303 depending on the approach.

It should also be noted that the various processes included in method 300 are in no way intended to be limiting, e.g., as would be appreciated by one skilled in the art after reading the present description. For instance, data sent from node 302 to node 301 may be prefaced by a request sent from node 301 to node 302 in some approaches. Additionally, the number of nodes included in FIG. 3A is in no way intended to be limiting. For instance, additional electronic devices at respective participant locations may be included in some approaches, e.g., depending on the size and/or details of a group video call. Accordingly, any desired number of electronic devices may be connected to the central server, e.g., as would be appreciated by one skilled in the art after reading the present description.

As shown in the flowchart, method 300 includes generating a screen sharing video stream. See operation 304. The screen sharing video stream may be generated at node 302 in correlation with a video call being conducted between nodes 302 and 303. In another approach, the screen sharing video stream may be generated at node 301 in correlation with a video call being conducted between nodes 302 and 303, e.g., as where node 302 is a client and node 301 is a server that provides a remote desktop to node 301, which is in turn created based on information received from node 302. In yet another configuration, a different computer (not shown) may act as a server and node 302 as a client, where the different computer provides the video stream to node 301. In any of these configurations, the computer/server that creates the video stream may be considered the presenter's computer.

In a preferred approach, the screen sharing video stream may be initiated by an application running on a presenter's computer in response to the presenter selecting an option (e.g., logical button) to share the contents of their computer screen to the other participants of a group video call. According to an example, one or more inputs may be received from a presenter in response to interacting with a UI on their computer. Node 302 may thereby be considered the presenter location, while node 303 is considered a participant location, e.g., as mentioned above. However, it should be noted that the number of nodes in FIG. 3A is in no way intended to be limiting. Any desired number of nodes, each corresponding to a respective participant of a group call, may be included. Audio and/or visual information may thereby be exchanged between the presenter and any number of participants on the group video call, e.g., using a video stream that combines the audio signals and/or sequential images captured.

Proceeding from operation 304 to operation 306, there the screen sharing video stream is sent from the presenter location at node 302, to a central server at node 301. In response to receiving the screen sharing video stream from the presenter at node 302, method 300 advances from operation 306 to operation 308. There, operation 308 includes analyzing the screen sharing video stream, while operation 310 includes identifying application information and navigation actions included therein. In some approaches, one or more AI based models may be trained to analyze the video stream and/or identify the application information as well as the navigation actions.

Referring momentarily now to FIG. 3B, exemplary sub-operations of identifying application information and navigation actions in a screen sharing video stream are illustrated in accordance with one approach. It follows that one or more of these sub-operations may be used to perform operation 310 of FIG. 3A. However, it should be noted that the sub-operations of FIG. 3B are illustrated in accordance with one approach which is in no way intended to be limiting.

Sub-operation 350 includes generating keyframes for the screen sharing video stream. As used herein, a “keyframe” refers to a marker that is used to identify a specific point in the video stream. For example, keyframes may be used to identify a screen change that occurs in the screen sharing video stream received from the presenter. As used herein, the term “screen change” is intended to refer to a significant change in the details that are presented (e.g., visible) in a video stream. In preferred approaches, the keyframes are visual markers that correspond to screen changes that occur during a screen sharing video stream. According to an example, a keyframe may be created each time the presenter advances to a next slide in a presentation. The different slides in the presentation may be identified by monitoring information correlated with each pixel of the presenter's computer screen and identifying changes that impact a predetermined number of the pixels. In other approaches, changes to the details presented in a video stream may be identified in response to physical and/or logical inputs received from the presenter. For example, receiving a signal in response to a presenter depressing a physical button on their keyboard, saying a predetermined phrase, using a computer mouse to select a logical button on a UI, etc. may indicate that a screen change has occurred. Moreover, this signal may be used to identify a screen change in the screen sharing video stream.

The flowchart advances from sub-operation 350 to sub-operation 352. There, sub-operation 352 includes identifying application static information from the keyframes. In other words, the keyframes formed in sub-operation 350 are evaluated and used to determine whether any application details in the keyframes themselves are static. Depending on the approach, the application static information identified from the keyframes may include an application type, application title, fixed area(s) in the application, content area(s) in the application, etc. Moreover, application static information may be identified in the keyframes using object detection and/or image processing techniques. In some approaches, one or more AI based models may be trained to inspect details in and/or associated with the keyframes (e.g., the status of each pixel on the presenter's computer screen) and identify details that do not change over a predetermined amount of time, during specific operations, in response to a predetermined condition being met, etc.

Advancing from sub-operation 352 to sub-operation 354, there the flowchart includes capturing navigation actions which cause screen change. In other words, sub-operation 354 includes monitoring the inputs that are provided by the presenter and identifying ones of the inputs that result in (coincide with) a change to what is displayed on the screen of the presenter's computer which is generating the screen sharing video stream. As noted above, “screen change” is intended to refer to a significant change in the details that are presented (e.g., visible) in a video stream. Sub-operation 354 thereby preferably includes identifying navigation inputs provided by the presenter which result in the screen change(s) occurring.

In some approaches, the process of capturing navigation actions which cause screen change includes identifying monitoring actions taken by the presenter and flagging certain ones of the identified actions. For example, certain actions may be preset as being of interest and undergo supplemental analysis as a result. An illustrative list of navigation actions that may result in screen change includes element click events, scrollbar changes, adjustments to zoom, etc. Accordingly, the actions taken by the presenter may be monitored throughout a video call and any such navigation actions are used to identify screen changes in the transmitted screen sharing video stream. Other available information may also be evaluated in order to evaluate the actions of the presenter and/or the content in the video stream itself. For example, in preferred approaches, vocal inputs (e.g., explanations) received from the presenter are leveraged (e.g., interpreted and evaluated) during the process of identifying navigation actions that result in screen change. In other approaches, body language (e.g., hand gestures, facial expressions, etc.) of the presenter, the tone and/or volume of the presenter while speaking, etc., may be taken into consideration while identifying navigation actions that cause screen change in the video stream.

Proceeding from sub-operation 354 to sub-operation 356, there duplicate keyframes are identified. In other words, the keyframes that are formed in sub-operation 350 are inspected in order to determine whether any duplicate (e.g., repeat) keyframes exist. Duplicate keyframes may be formed in response to the presenter revisiting the same content (e.g., revisiting a same slide), zooming in and/or out on content (e.g., adjusting the view of a slide), etc. Depending on the approach, two keyframes that have at least 50%, 51%, 52%, 53%, 55%, 60%, 70%, 80%, 90%, 95%, etc., of the same pixels (e.g., visual details) therein may be considered duplicates. In other approaches, two keyframes having at least 50%, 51%, 52%, 53%, 55%, 60%, 70%, 80%, 90%, 95%, etc., matching text therein may be considered duplicates. The process of comparing the keyframes to identify duplicates therein may thereby vary depending on what details are relevant in making the determination.

Referring still to FIG. 2B, the flowchart advances from sub-operation 356 to sub-operation 358. There, sub-operation 358 includes capturing application switching, link source, and target application information. In other words, sub-operation 358 includes obtaining additional information that will assist in identifying portions of a video stream which display relevant information, e.g., as will be described in further detail below.

Returning now to FIG. 3A, method 300 advances from operation 310 to operation 312. There, operation 312 includes generating navigation metadata in real-time. In other words, operation 312 includes evaluating the application information and navigation actions identified from the keyframes in operation 310. Moreover, results of the evaluation are used to generate navigation metadata that effectively represents at least portions of the application information and navigation actions that are of interest. For instance, at least application static information and dynamic navigation actions may be identified from the navigation metadata. As alluded to above, application static information is not of interest, as it is redundant and at least partially causes duplicate keyframes to be formed. However, dynamic navigation actions performed by the presenter may cause screen change events to occur, and thereby provide valuable insight into whether given keyframes are of particular interest.

From operation 312, method 300 advances to operation 314. There, operation 314 includes causing the navigation metadata to be used to reorganize keyframes and build up a virtual desktop. In other words, operation 314 includes sending one or more instructions to node 303 (e.g., see step 314a) that cause one or more processors to use the navigation metadata to reorganize keyframes and build up the virtual desktop. See operation 316. The process or reorganizing the keyframes preferably uses the insight gained by evaluating the keyframes and actions taken by the presenter during the video stream, to organize the keyframes in a desired arrangement. For instance, keyframes may be divided into groups that correspond to the respective applications that were in use when the keyframes were formed. The keyframes may also be arranged in a chronological order, based on an amount of unique information (e.g., resulting from dynamic navigation actions) therein, based on size, etc.

Referring momentarily to FIG. 3C, exemplary sub-operations of using the navigation metadata to reorganize keyframes and making them available to build up (e.g., form) a virtual desktop are illustrated in accordance with one approach. It follows that one or more of these sub-operations may be used to perform operation 314 and/or 316 of FIG. 3A. However, it should be noted that the sub-operations of FIG. 3C are illustrated in accordance with one approach which is in no way intended to be limiting. For instance, one or more of the sub-operations in FIG. 3C may be performed by one or more of the components illustrated in FIG. 2B.

Looking to FIG. 3C, sub-operation 360 includes grouping keyframes into applications. In other words, sub-operation 360 includes organizing the keyframes into groups, such that each group of keyframes corresponds to a same application that was running (e.g., in use) while the respective keyframes were formed. In some approaches, this grouping may be based at least in part on the application static information and/or the dynamic navigation actions identified above. Grouping the keyframes based on the underlying application desirably allows for similar (but not duplicate) keyframes to be near each other. As a result, a virtual desktop that permits participants of a video call to more efficiently access desired content from the video call itself is achievable, e.g., as will be described in further detail below.

Proceeding now to sub-operation 362, there the flowchart includes displaying the grouped keyframes in an application view. In other words, the keyframes are used to generate respective views of the corresponding applications. Accordingly, the keyframes are preferably arranged into groups that correspond to the respective applications in use while the keyframes were formed, e.g., as opposed to a chronological or timeline based arrangement. Moreover, sub-operation 364 includes rendering hotspots on the keyframes based at least in part on the dynamic navigation actions. Thus, at least the dynamic navigation actions included in the navigation metadata generated in operation 312 of FIG. 3A are used to identify hotspots on the keyframes. With respect to the present description, “hotspots” on a keyframe are intended to refer to areas in a grouping of keyframes which experience changes to the content therein. Hotspots may thereby identify areas in keyframes that correspond to a same application, which change across the keyframes in that group. This information is desirable, as it may be used to direct a participant's attention to a specific area of a keyframe, add supplemental information to a keyframe, integrate navigation inputs that are available to participants, etc.

From sub-operation 364, the flowchart advances to sub-operation 366. There, sub-operation 366 includes using an action handler to display a next expected keyframe. Sub-operation 366 may thereby include causing a logical button, icon, thumbnail, etc., to be displayed in a GUI that is configured to be deployed by a virtual desktop. It follows that the next expected keyframe may be displayed on a GUI at a participant location in response to deploying the virtual desktop.

Returning now to FIG. 3A, it should be noted that in some approaches, the virtual desktop may be created at the central server at node 301 and sent to the participant of the screen sharing video stream at node 303. As previously mentioned, the number of nodes illustrated in FIG. 3A is in no way intended to be limiting. Copies of the same virtual desktop and/or unique virtual desktops may thereby be sent to any number of respective participants that are part of the same group video call as the presenter at node 302, e.g., as would be appreciated by one skilled in the art after reading the present description. The virtual desktop may be sent to the participant along with (e.g., in parallel with) at least a portion of the screen sharing video stream and/or other supplemental information.

Advancing now to operation 318, there method 300 includes loading a current application in the virtual desktop. In other words, operation 318 includes deploying the virtual desktop (e.g., using a controller at node 303), in addition to loading an application, that is currently being utilized in the received screen sharing video stream, into the virtual desktop. Moreover, operation 320 includes using the current application to display the screen sharing video stream. As noted above, while the screen sharing video stream may originate at node 302, it is preferably sent to node 301 for dynamic evaluation, processing, etc., before being sent to node 303. However, in some approaches, one copy of the screen sharing video stream may be sent from the presenter at node 302 to node 301, while a second copy of the screen sharing video stream may be sent from node 302 to the participant(s) at node(s) 303 (and/or others).

Method 300 advances from operation 320 to operation 322. There, operation 322 includes receiving one or more navigation inputs from a participant. The navigation inputs may be provided by the participant at node 303 while interacting with a GUI that is deployed in the virtual desktop. The GUI thereby communicates with and/or otherwise interacts with the virtual desktop deployed at node 303. The navigation inputs received from the participant may include switching between displayed applications and/or adjusting a view in a given (e.g., visible) application. It should also be noted that although the participant is able to change the video call information that is currently visible, the participant is preferably presented with an option (e.g., a logical button) that allows the participant to return to the current (e.g., live or real-time) screen sharing video stream being received (e.g., indirectly) from the presenter. For example, the navigation inputs may include switching between application(s) previously presented to the participant, using a computer mouse to scroll (e.g., up, down, right, left, etc.) in a current view of the screen sharing video stream, clicking one or more logical and/or physical buttons that are displayed in a GUI or otherwise correspond to the current view of the screen sharing video stream, etc.

In response to receiving the navigation inputs at operation 322, method 300 advances to operation 324. There, operation 324 includes causing the virtual desktop to be updated to reflect the one or more navigation inputs. In some approaches, the virtual desktop may be updated by adjusting the participant's view of the current application in the video stream. In other approaches, the virtual desktop is updated to depict a specific portion of a previous (i.e., different) application in the video stream. Operation 324 may thereby include modifying the virtual desktop such that the navigation inputs impact the view available to the participant. The participant may continue to view specific portions of the content that has been presented until they wish to return to the live video stream. The participant may select a logical button displayed on the virtual desktop that is configured to cause the screen sharing video stream to be displayed in real-time, e.g., as it is received.

However, it should be noted that in some approaches, the virtual desktop may be updated at another location (e.g., a central server) and sent to the participant location of node 303.

It follows that the operations of method 300 are desirably able to facilitate participants navigating through applications shared during a group call. For instance, method 300 is able to identify application static information from keyframes in a screen sharing video stream received from a presenter. Moreover, by capturing actions which cause screen change, the actions may be bound with respective keyboard events and/or element events. The keyframes are further reorganized and used to build a virtual desktop which contains applications displayed by the presenter. Accordingly, a participant is able to interact with the virtual desktop to view a desired application, even using inputs (e.g., a keyboard, computer mouse, touchscreen, etc.) to navigate in the desired application. Participants of a group video call are thereby able to obtain customized and focused views of what the presenter has displayed during the screen sharing video stream. This allows the participants of the video call to revisit any portion of what the presenter shared and even navigate through the content during an ongoing meeting, e.g., as if the participants were each navigating through their own respective environments.

In some approaches, the operations of method 300 may be performed by an AI model that is trained using a predetermined training set of data. For example, in some approaches, various of the operations noted above may be deployed in a trained state of a trained AI model (e.g., see AI module 213 of FIG. 2A). Training of the AI model, in some approaches, may be performed by applying a predetermined training data set to learn how to evaluate video streams and identify content of interest. For example, one or more AI based models may be trained to evaluate screen sharing video streams and identify applications that are being used by a presenter while creating the video stream, as well as navigation actions that are performed by the presenter. Moreover, the AI based models may be trained to generate and update navigation metadata which corresponds to actions taken by the presenter in real-time. Further still, AI based models may be trained (and re-trained) to use the navigation metadata to reorganize keyframes and at least partially build a virtual desktop configured to be deployed at the location of a participant of a group video call. As noted above, this has previously been unachievable.

Initial training may include reward feedback that may, in some approaches, be implemented using a subject matter expert (SME) that generally understands how to identify changes in content presented on a video stream. However, to prevent costs associated with relying on manual actions of a SME, in another approach, reward feedback may be implemented using techniques for training a BERT model, as would become apparent to one skilled in the art after reading the present disclosure. Once a determination is made that the AI model achieves a redeemed threshold of accuracy of performing the operations described herein during this training, a decision that the model is trained and ready to deploy for performing techniques and/or operations of method 300 may be performed. In some further approaches, the AI model may be a neuromyotonic AI model that may improve performance of computer devices in an infrastructure associated with video streams and the applications that are used therein, as well as how navigation actions performed by the presenter impact a virtual desktop configured to be deployed at the location of a participant of a group video call, because the neuromyotonic AI model may not need an SME and/or iteratively applied training with reward feedback in order to accurately perform operations described herein. Instead, the neuromyotonic AI model is configured to itself make determinations described in operations herein.

Weight values may, in some approaches, be used by the AI reasoning model to collect and analyze information and/or feedback potentially received in response to the virtual desktop being updated in response to input provided by a presenter and/or participant of a group video call. Such an AI model ensures that re-training occurs, during which the accuracy of selections made by the AI model(s) is evaluated. In situations where the accuracy of the selections decline, the data used train the AI model(s) may be shifted (e.g., weighted) such that the AI model(s) cause the virtual desktop to modify the content that is displayed in a video stream and/or locally to a participant, where the scale of such analysis and determinations would not otherwise be feasible for a human to perform. This is because humans are not able to efficiently perform complex re-training resulting from dynamic evaluation of specific inputs and/or metrics that are identified as being relevant, and would otherwise incorporate processing delays and errors in the process of attempting to do so. Accordingly, management of operations described herein is not able to be achieved by human manual actions.

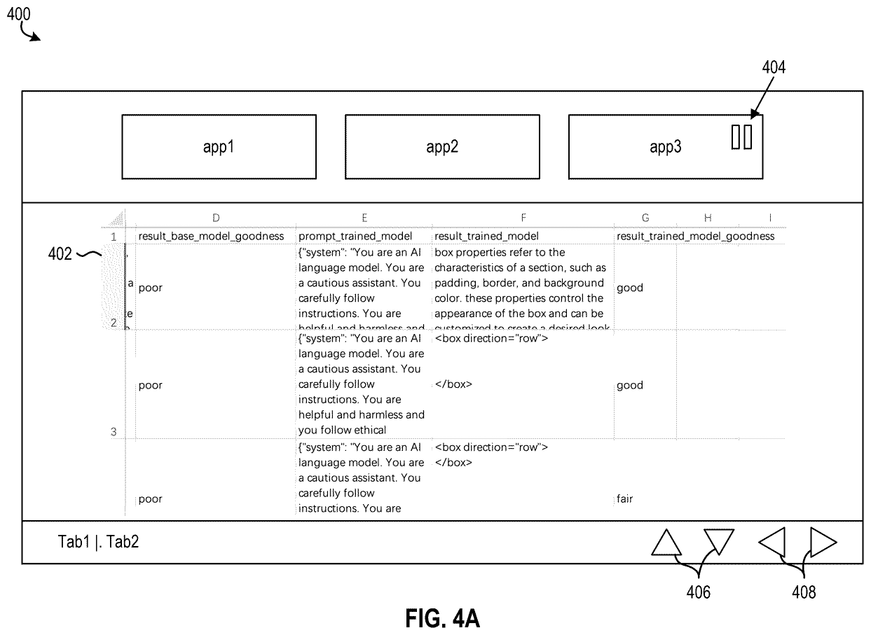

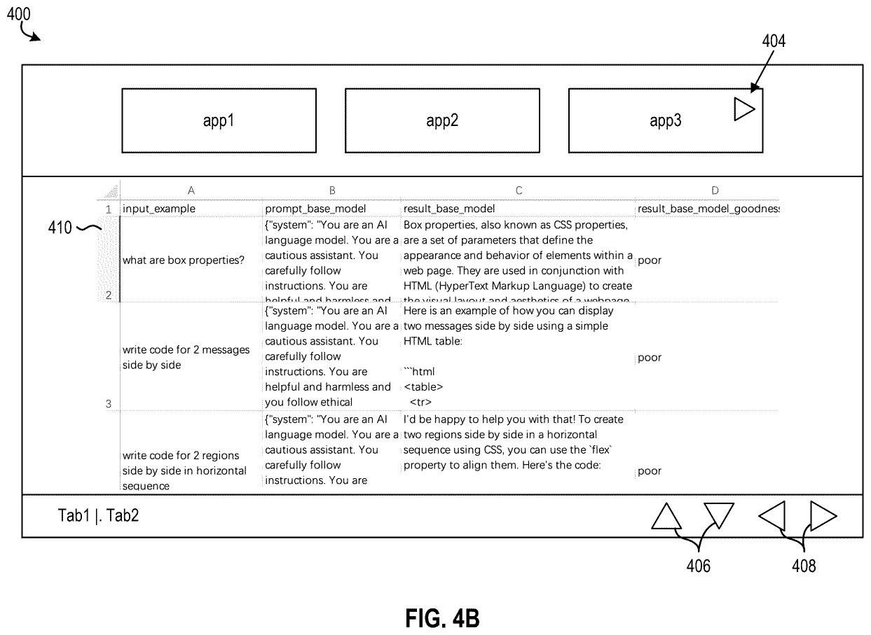

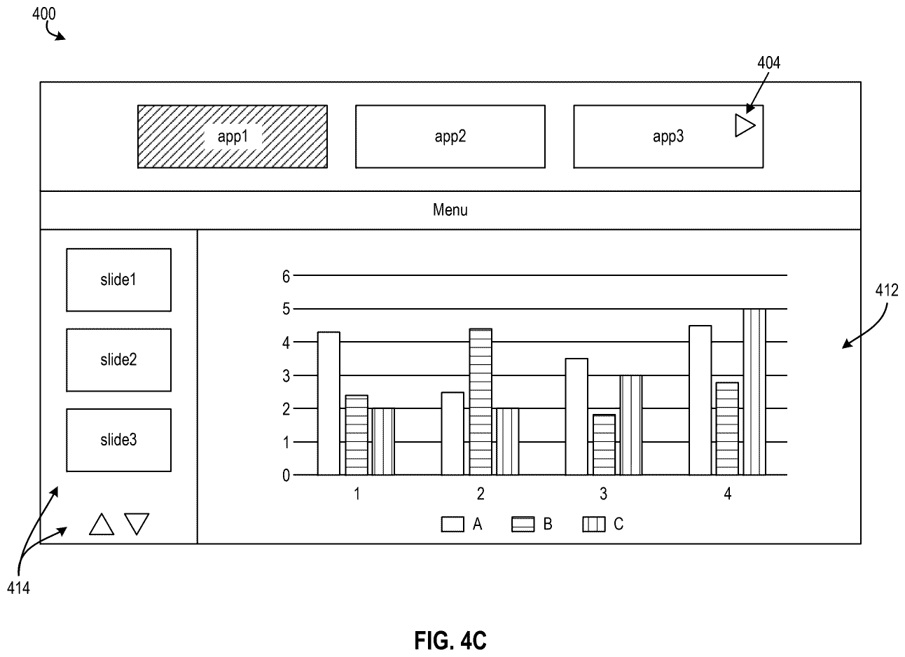

Looking now to FIGS. 4A-4C, different representational views of the GUI that corresponds to a virtual desktop deployed at the location of a participant on a group video call are illustrated in accordance with an in-use example which is in no way intended to be limiting.

Looking first to FIG. 4A, there the GUI 400 of a virtual desktop shows a live view 402 of a screen sharing video stream. The current view icon 404 reflects this information by indicating the participant is currently following the live focus of the presenter. Moreover, the current view icon 404 is overlayed on a logical button that corresponds to the current application “app3” being displayed in the screen sharing video stream. Logical buttons “app1” and “app2” also exist for applications used by the presenter earlier in the screen sharing video stream, e.g., as described in further detail below.

At the bottom of the GUI 400, the directional arrows 406, 408 may also be logical buttons that may be selected by the presenter in response to interacting with the GUI 400. For example, the presenter may use a computer mouse, one or more physical buttons on a keyboard, a touchscreen, a stylus, etc., to select either of logical buttons 406 to effectively scroll up or down, and/or either of logical buttons 408 to effectively scroll right or left, respectively.

For example, FIG. 4B illustrates an updated view 410 of the current application, e.g., based on the directional inputs provided by the participant of the video call. There, the virtual desktop has been updated in response to the participant selecting one or more of the directional arrows 406, 408. Accordingly, the content visible in the GUI 400 is different than the content that was previously visible (see FIG. 4A), despite being in a same application. In response to the participant's attention being directed to a specific portion of the current application, the current view icon 404 is shown as being updated to reflect that the participant is no longer viewing the live video stream. In some approaches, the participant may be able to select the current view icon 404 in order to return to the live view of the video stream. In other approaches, a dedicated logical and/or physical button may be configured to return to the live view.

Referring now to FIG. 4C, the GUI 400 has been updated again in response to the participant selecting the logical button corresponding to “app1”. Accordingly, the updated view 412 shows information that was previously presented in the video call in the context of the corresponding application, e.g., as shown. Again, the current view icon 404 is shown as being updated to reflect that the participant is no longer viewing the live video stream. In some approaches, the participant may be able to select the current view icon 404 in order to return to the live view of the video stream in the current application “app3”. In other approaches, a dedicated logical and/or physical button may be configured to return to the live view. Additionally, updated navigation options 414 are made available to the participant while viewing the information presented in the context of “app1”. These updated navigation options 414 may be used to switch between slides presented during the video call using “app1”, e.g., as would be appreciated by one skilled in the art after reading the present description.

Again, approaches herein are desirably able to improve participant experience during online meeting. This is achieved at least in part by generating navigation metadata by identifying application components and extracting navigation actions from content that is shared over a video stream (e.g., screen sharing video stream). Moreover, keyframes may be reorganized in a specific arrangement that allows for classification, deduplication, reordering of application switching, composition of view fragments while scrolling, etc. Creating and updating a virtual desktop at each participant of the video call displays the presenter's applications based on navigation static metadata. Rendering hotspots on keyframes allows for an action handler to be added in the virtual desktop application, e.g., based at least in part on navigation dynamic metadata. Application content may thereby be navigated in response to actions received in the participant virtual desktop, e.g., as described herein.

This allows the participants to navigate content shared during the video stream in a flexible way that makes it seem as if the participant is working in a local compute environment. Approaches herein also enhance the impact of online meetings by allowing audience members to access customized (e.g., focused) views of content shared by a presenter. This further facilitates meeting discussion, and provides exchange navigation metadata that allows for specific content to be located quickly.

It will be clear that the various features of the foregoing systems and/or methodologies may be combined in any way, creating a plurality of combinations from the descriptions presented above.

It will be further appreciated that approaches of the present invention may be provided in the form of a service deployed on behalf of a customer to offer service on demand.

The descriptions of the various approaches of the present invention have been presented for purposes of illustration, but are not intended to be exhaustive or limited to the approaches disclosed. Many modifications and variations will be apparent to those of ordinary skill in the art without departing from the scope and spirit of the described approaches. The terminology used herein was chosen to best explain the principles of the approaches, the practical application or technical improvement over technologies found in the marketplace, or to enable others of ordinary skill in the art to understand the approaches disclosed herein.

What is claimed is:

1. A method comprising:
in response to receiving a screen sharing video stream from a presenter's computer, analyzing the screen sharing video stream;
identifying application information and navigation actions included in the screen sharing video stream;
generating navigation metadata in real-time, the navigation metadata including application static information and dynamic navigation actions;
sending the navigation metadata to at least one participant of the screen sharing video; and
causing the at least one participant to reorganize keyframes and build up a virtual desktop using the navigation metadata.

2. The method of claim 1, wherein the identifying application information and navigation actions included in the screen sharing video stream includes:
identifying application static information from keyframes using object detection and image processing techniques,
capturing navigation actions which cause screen change;
identifying duplicate keyframes; and
capturing application switching, link source, and target application.

3. The method of claim 2, wherein the capturing navigation actions which cause screen change includes:
identifying element click events;
identifying scrollbar change; and
leveraging vocal input received from the presenter.

4. The method of claim 2, wherein the application static information identified from the keyframes is selected from the group consisting of: application type, title, fixed area, and content area.

5. The method of claim 1, wherein the screen sharing video stream is part of a video call connecting the presenter with the participant and one or more other participants, wherein audio and visual information is exchanged between the presenter and the participants.

6. A computer program product comprising:
one or more computer-readable storage media; and
program instructions stored on the one or more storage media to perform operations comprising:
in response to receiving a screen sharing video stream from a presenter's computer, analyzing the screen sharing video stream;
identifying application information and navigation actions included in the screen sharing video stream;
generating navigation metadata in real-time, the navigation metadata including application static information and dynamic navigation actions;
sending the navigation metadata to at least one participant of the screen sharing video; and
causing the at least one participant to reorganize keyframes and build up a virtual desktop using the navigation metadata.

7. The computer program product of claim 6, wherein the identifying application information and navigation actions included in the screen sharing video stream includes:
identifying application static information from the keyframes using object detection and image processing techniques,
capturing navigation actions which cause screen change;
identifying duplicate keyframes; and
capturing application switching, link source, and target application.

8. The computer program product of claim 7, wherein the capturing navigation actions which cause screen change includes:
identifying element click events;
identifying scrollbar change; and
leveraging vocal input received from the presenter.

9. The computer program product of claim 7, wherein the application static information identified from the keyframes is selected from the group consisting of: application type, title, fixed area, and content area.

10. The computer program product of claim 6, wherein the screen sharing video stream is part of a video call connecting the presenter with the participant and one or more other participants, wherein audio and visual information is exchanged between the presenter and the participants.

11. A computer system comprising:
a processor set;
one or more computer-readable storage media; and
program instructions stored on the one or more storage media to cause the processor set to perform operations comprising:
in response to receiving a screen sharing video stream from a presenter's computer, analyzing the screen sharing video stream;
identifying application information and navigation actions included in the screen sharing video stream;
generating navigation metadata in real-time, the navigation metadata including application static information and dynamic navigation actions;
sending the navigation metadata to at least one participant of the screen sharing video; and
causing the at least one participant to reorganize keyframes and build up a virtual desktop using the navigation metadata.

12. The computer system of claim 11, wherein the screen sharing video stream is part of a video call connecting the presenter with the participant and one or more other participants, wherein audio and visual information is exchanged between the presenter and the participants.

13. The computer system of claim 11, wherein the identifying application information and navigation actions included in the screen sharing video stream includes:
identifying application static information from the keyframes using object detection and image processing techniques,
capturing navigation actions which cause screen change;
identifying duplicate keyframes; and
capturing application switching, link source, and target application.

14. The computer system of claim 13, wherein the capturing navigation actions which cause screen change includes:
identifying element click events;
identifying scrollbar change; and
leveraging vocal input received from the presenter.

15. The computer system of claim 13, wherein the application static information identified from the keyframes is selected from the group consisting of: application type, title, fixed area, and content area.

16. A method comprising:
receiving navigation metadata from a central server;
using the navigation metadata to reorganize keyframes and build up a virtual desktop;
loading a current application in the virtual desktop;
using the current application to display a screen sharing video stream received from a presenter's computer; and
in response to receiving one or more navigation inputs from a participant, updating the virtual desktop to reflect the one or more navigation inputs,
wherein the one or more navigation inputs are received from the participant in response to interacting with a user interface (UI) that corresponds to the virtual desktop,
wherein the one or more navigation inputs include switching between displayed applications and/or adjusting a view in a current application.

17. The method of claim 16, wherein the one or more navigation inputs are received from the participant in response to interacting with a user interface (UI) that corresponds to the virtual desktop.

18. The method of claim 17, wherein the one or more navigation inputs include switching between displayed applications and/or adjusting a view in a current application.

19. The method of claim 16, wherein the navigation metadata includes application static information and dynamic navigation actions, wherein the using the navigation metadata to reorganize keyframes and build up the virtual desktop includes:
grouping keyframes into applications;
displaying keyframes in an application view; and
rendering hotspots on the keyframes based at least in part on the dynamic navigation actions.

20. The method of claim 16, wherein the screen sharing video stream is part of a video call connecting the presenter with the participant and one or more other participants, wherein audio and visual information is exchanged between the presenter and the participants.

21. A computer program product comprising:
one or more computer-readable storage media; and
program instructions stored on the one or more storage media to perform operations comprising:
receiving navigation metadata from a central server;
using the navigation metadata to reorganize keyframes and build up a virtual desktop;
loading a current application in the virtual desktop;
using the current application to display a screen sharing video stream received from a presenter's computer; and
in response to receiving one or more navigation inputs from a participant, updating the virtual desktop to reflect the one or more navigation inputs,
wherein the one or more navigation inputs are received from the participant in response to interacting with a user interface (UI) that corresponds to the virtual desktop,
wherein the one or more navigation inputs include switching between displayed applications and/or adjusting a view in a current application.

22. The computer program product of claim 21, wherein the one or more navigation inputs are received from the participant in response to interacting with a user interface (UI) that corresponds to the virtual desktop.

23. The computer program product of claim 22, wherein the one or more navigation inputs include switching between displayed applications and/or adjusting a view in a current application.

24. The computer program product of claim 21, wherein the navigation metadata includes application static information and dynamic navigation actions, wherein the using the navigation metadata to reorganize keyframes and build up the virtual desktop includes:
grouping keyframes into applications;
displaying keyframes in an application view; and
rendering hotspots on the keyframes based at least in part on the dynamic navigation actions.

25. The computer program product of claim 21, wherein the screen sharing video stream is part of a video call connecting the presenter with the participant and one or more other participants, wherein audio and visual information is exchanged between the presenter and the participants.
